(19) United States
(12) Patent Application Publication
(10) Pub. No.: US 2003/0150157 A1
(43) Pub. Date: Aug. 14, 2003

(54) Growth barrier

(76) Inventor: Steve Carkner, Ottawa (CA)

Correspondence Address: GORDON THOMSON, 1353 MOUNTAINSIDE CRES., OTTAWA, ON, K1E 3G5, CA

(21) Appl. No.: 10/115,075

(22) Filed: Apr. 4, 2002

(30) Foreign Application Priority Data
Feb. 8, 2002 (CA) CA 237051

(51) Int. Cl. A01G 1/00

(52) U.S. Cl. 47/33

(57) ABSTRACT

A reusable non-biodegradable plant growth barrier is disclosed comprising at least one flat rectangular body for removable placement in communication with soil for cultivation. The body comprises a frame defining an area of prohibited plant growth. The frame forms a rectangular slit exposing soil for cultivation of desirable plants. A plurality of barriers may be attached together to define a planting pattern across a predetermined cultivation area. The barrier includes for means for irrigating the soil below the growth barrier and is anchored to the soil using a plurality of spikes. Division members may be inserted into the frame to form a plurality of cultivation slits.

### CROSS REFERENCE TO RELATED APPLICATIONS

This application is related to Canadian Patent Application #2370571 filed in the Canadian Intellectual Property Office on Feb. 8, 2002 and claims priority therefrom.

### BACKGROUND OF THE INVENTION

1. Field of the Invention

This invention relates to the field of plant cultivation and husbandry and more specifically to a growth barrier preventing undesirable plant growth in gardens while permitting the adaptation of a desired cultivation pattern.

2. Discussion of the Prior Art

Apparatus and methods to prevent growth of weeds and other unwanted plants around desirable plants are well known. For example, chemicals, organic and artificial mulch and physical barriers are employed singly or in combination to stop growth of weeds amongst cultivated plants. Examples of known art include Canadian Patent 1264999 entitled “Degradable Agricultural Mulch Sheeting” issued to Shanley and Lubar on Jan. 30, 1990; Canadian Patent 2125815 entitled “Ground Cover Sheet Formed of Variable Biodegradable Cellulosic Fibre Composition and Method of Making Same” issued to Demarais et al on Sep. 15, 1995; and Canadian Patent 2201727 entitled “Mulching Composite” issued to Sands et al on Feb. 27, 1997. One disadvantage to these inventions is that they require the application of weighting means to their top surfaces to prevent the growth barrier from being damaged or lost in adverse weather. Another disadvantage to these inventions is that they must be stabilized with spikes or staples that must penetrate the barrier and subsequently damage it. A further disadvantage to these growth barriers is that they impede the flow of water into the soil underneath the barrier. Another disadvantage to these inventions is that they tend to require the addition of chemicals to suppress plant growth and they tend to be biodegradable and therefore are temporary and not reusable.

Therefore, there continues to be a need for a reusable growth barrier that is easily placed on the soil for cultivation, does not biodegrade, does not require additional chemical treatment and can remain in place without the need for a plurality of barrier damaging spikes and staples.

### SUMMARY OF THE INVENTION

It is an object of my invention to overcome the deficiencies in the known art cited above. It is further an object of my invention to provide a reusable growth barrier that does not require the addition of chemicals to prevent plant growth and permits the irrigation of soil beneath the barrier. It is a further object of my invention to provide a growth barrier that is easily installed and anchored in place without the need for additional weighting means placed upon it. Another object of my invention is to permit the harvesting of produce while the barrier remains in place without damaging the barrier when extracting the plant.

To meet these objects my invention provides for a plant growth barrier comprising at least one flat rectangular body for removable placement on soil for cultivation. The body comprises a frame having a top member, a bottom member a first side member and a second side member. The members are integral to each other, that is to say, the frame is cut as a single piece from the manufacturing material. The area of the frame members defines the area of prohibited growth so the frame members are suitably sized to prevent plant growth over a desired area. Also included in my growth barrier is at least one rectangular slit enclosed by the frame members. The slit exposes soil for cultivation of desirable plants. The slits are also adapted to receive plant spacing means. To cover large areas of cultivation the bodies may be attached together to define a planting pattern. To ensure that the soil beneath the growth barrier is irrigated my invention provides for means for deep irrigating the soil below the growth barrier. The barrier is anchored to the soil by anchoring means.

In another embodiment of my invention there is provided at least one division member connected to the top and bottom members and parallel to the side members of the frame. The division member results in the formation of two identically dimensioned slits for exposing soil for cultivation. In this embodiment, the division member is integral to the body so that the frame and division member are manufactured from a single piece of material.

In yet another embodiment of my invention wherein the body frame includes a plurality of divisional members between the top and bottom members of the frame to form a plurality of equally dimensioned slits in the body for exposing soil for cultivation.

In a preferred embodiment of my invention the bodies are joined together by a plurality of flexible “mushroom” shaped projections on the first side member and the top member of the frame of the body and a plurality of flexible “mushroom” shaped slots in the second side member and bottom member of the frame of the body. The slots and projections of adjacent bodies are designed to be aligned so that they may be fastened together to form light and water impermeable “shiplap” joints between the barriers. Other means of fastening may be used such as snaps, magnets, pin-in-hole devices and adhesive tape.

To ensure that there is proper irrigation of the soil beneath the growth barrier my invention includes means for irrigating the soil below the growth barrier comprising a plurality of circular apertures in the frame and division members. The apertures are sized to permit adequate water flow to the soil without water logging the soil beneath the growth barrier.

To anchor the growth barrier to the soil my invention includes means for anchoring comprising a plurality of elongate conical spikes. These spikes have a sieve structure of perforations, a base and an apex. The base is fixed to the underside of the body beneath an irrigation aperture so that moisture can enter the body of the spike and diffuse deep into the soil beneath the growth barrier. The said apex is adapted to readily penetrate soil for cultivation without undue effort on the part of an individual. In another embodiment of my invention, the spikes are moveably attached to the frame so that chemical fertilizers, insecticides or herbicides may be added to the spikes to infuse the soil with the chemicals at depth.

In another embodiment of my invention there is included plant spacing means comprising a rectangular member adapted for being received by the cultivation slit. The plant spacing means has at least one opening adapted for customized plant spacing. The member may have a plurality of openings adapted for customized plant spacing. The member is split down its centre line into two halves for easy insertion into the slit and for easy removal from the slit by halves without damaging plants growing therein.

In a further embodiment of my invention, the body includes a raised lip about its circumference in order to retain water on the surface of the body so that it is able to flow through the apertures and into the soil.

My invention is adapted for colouring and texturing to match the soil upon which it is placed. The material of construction of my invention is thermoplastic material having thermal gain properties to promote plant growth when exposed directly to solar radiation and being water and light impermeable. Such materials may include ABS plastic, rubber, polycarbonate or glass-reinforced nylon.

Further objects and advantages of my invention will become apparent from a consideration of the following detailed description and drawings,

### BRIEF DESCRIPTION OF THE DRAWINGS

FIG. 1 shows one embodiment of my invention having a single slit for cultivation.

FIG. 2 is another embodiment of my invention having two slits for cultivation.

FIG. 3 is a preferred embodiment of my invention having three slits for cultivation.

FIG. 4 illustrates the fastening means of a preferred embodiment of my invention to fasten a plurality of barriers together.

FIG. 5 shows in cross section the “shiplap” joint of my invention when the barriers are fastened together.

FIG. 6 shows in cross section the irrigation and anchoring spike of one embodiment of my invention.

FIG. 7 shows a variety of embodiments of the plant spacing means of my invention.

FIG. 8 illustrates the manner in which the plant spacing means of my invention is split into two halves.

### DETAILED DESCRIPTION

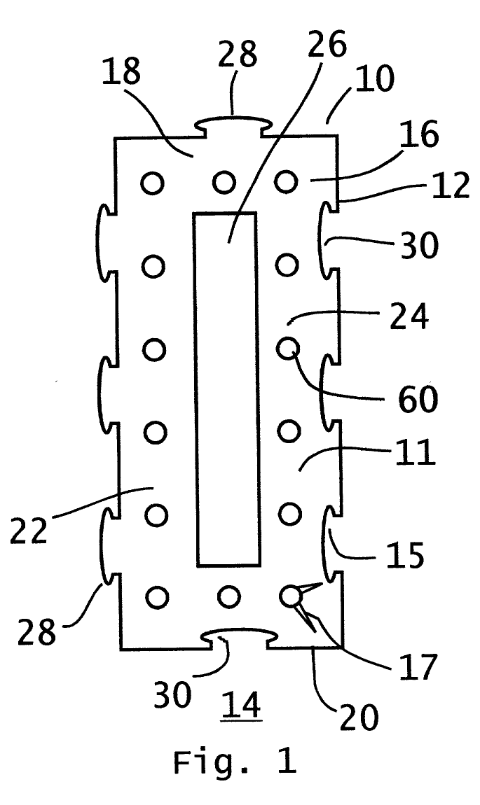

Referring to FIG. 1, there is shown a plant growth barrier of one embodiment of my invention (10) comprising at least one flat rectangular body (12) for removable placement in communication with soil for cultivation (14). The body has a top surface (11) and a bottom surface (15). The body also comprises a frame (16) having a top member (18), a bottom member (20) a first side member (22) and a second side member (24). The framing members are integral to each other and formed from a single piece of material. There are no joints between them. Each of the members has a suitable width and length. From FIG. 1, it is clear that the surface are of the frame (16) defines the area of soil that will be covered to prevent plant growth. The surface (11) of the body may contain grooves (17) to channel water, as more fully described below, from the surface of the body to the apertures (60).

Still referring to FIG. 1, there is shown a slit (26) enclosed by the frame (12). The slit defines that area of exposed soil through which plant growth is permitted. Within the slit, seeds or seedlings may be planted in a linear and equidistant pattern. As more fully described below the slit (26) is adapted to receive and hold a member that is adapted to assist in the desired spacing of plants.

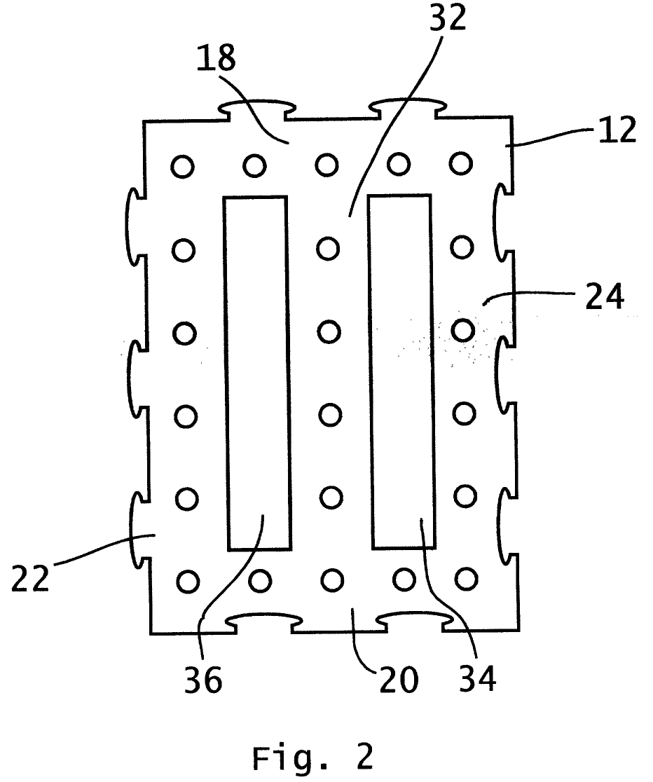

Referring now to FIG. 2, there is shown another embodiment of my invention. Frame (16) further includes at least one additional division member (32) connected to the top (18) and bottom (20) frame members. The division member is parallel to the side members (22) and (24) and results in the formation of two slits (34) and (36) for exposing soil for cultivation. The divisional member (32) is integral to the body and in this embodiment all the frame with division member is made from a single piece of material. The width of the division member is about equal to that of the other framing members.

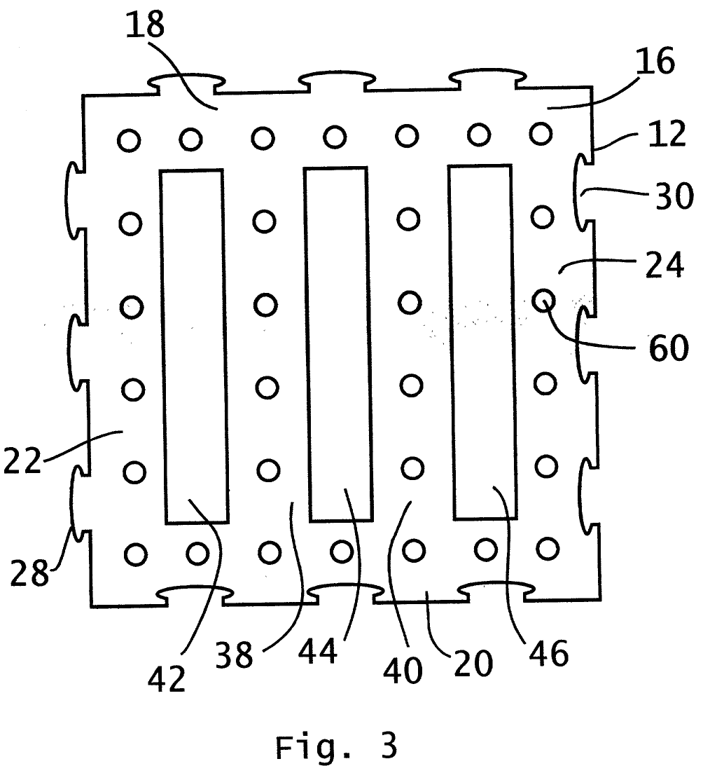

Referring to FIG. 3, there is shown a preferred embodiment of my invention comprising a frame (16) having two division members (38) and (40) and forming three slits (42), (44) and (46) for plant cultivation. A plurality of division members may be added to a frame to increase the number of cultivation slits to a desired amount.

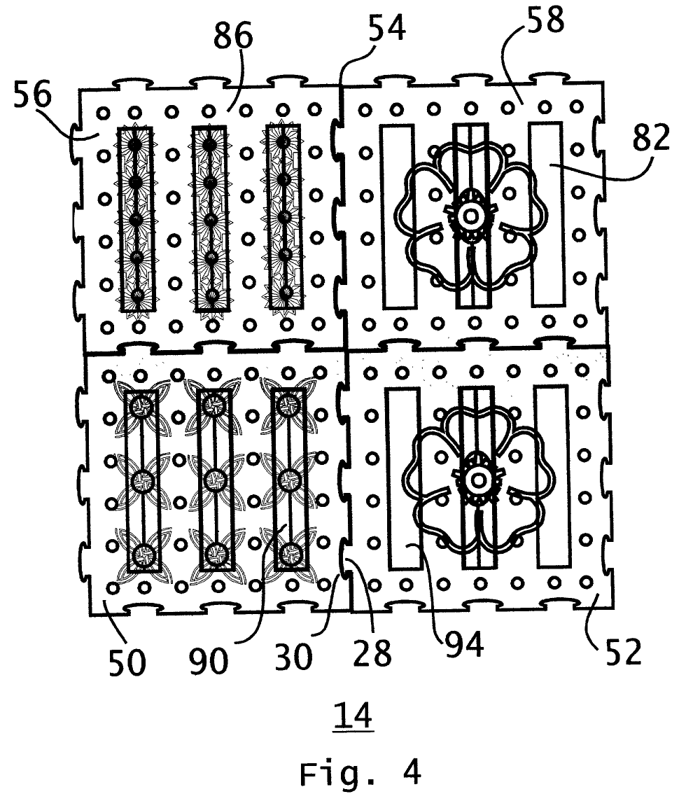

Also in FIGS. 1, 2 and 3 are means for attaching a plurality of bodies (12) together to define a planting pattern across a predetermined cultivation area. Shown are a plurality of “mushroom” shaped projections (28) from the first side member (22) and the top member (18) of the frame (16). As well there is included on the body of my invention a plurality of “mushroom” shaped slots (30) in the second side member (24) and bottom member (20) of the frame. As shown in FIG. 4, a plurality of bodies may be joined to form a desired cultivation pattern. When two bodies, say (50) and (52) are placed on the cultivation soil (14) adjacent to each other the projections (28) on one side of body (52) and slots (30) of the opposite side of body (50) are in adjacent alignment to each other. The bodies are coupled together by pressing or hooking the projections of the second body into and under the slots of the first body forming an interlocked joint (54) between the two bodies. Similarly, bodies (56) and (58) may be joined to the top sides of bodies (50) and (52). FIG. 4 shows the projections (28) being hooked underneath the slots (30) to form the joint (54).

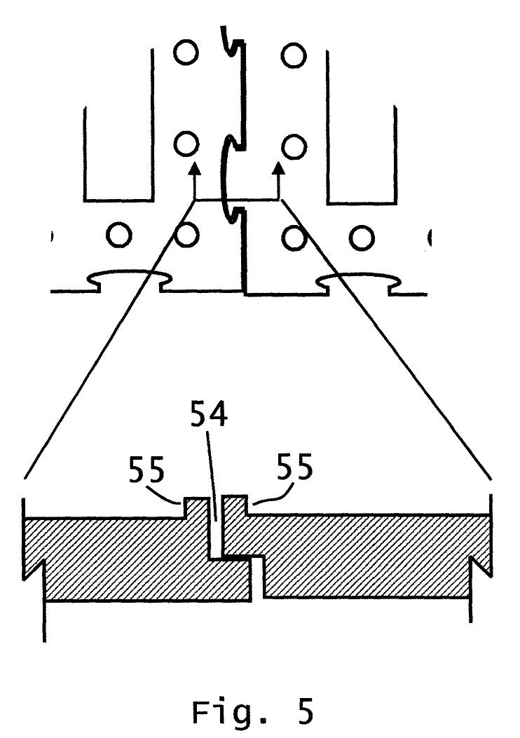

Referring to FIG. 5, there is shown the resulting “shiplap” joint (54) formed when two adjacent bodies are joined. Also shown in FIG. 5 are the lips (55) used to retain water on top of the bodies. Virtually no light and water will be permitted to pass into the joint so plant growth will not be encouraged through the joint. Other means may be used to successfully attach two bodies together such as snaps, magnets, pin-in-hole devices and adhesive tape.

Referring back to FIG. 3 there is shown means for irrigating the soil below the growth barrier. The irrigation means comprises a plurality of apertures (60) in the frame and division members. The apertures are circular and are adapted to permit sufficient irrigation under the growth barrier without water logging the soil beneath the growth barrier. The apertures are in an equally spaced linear alignment relationship down the centre line of each member.

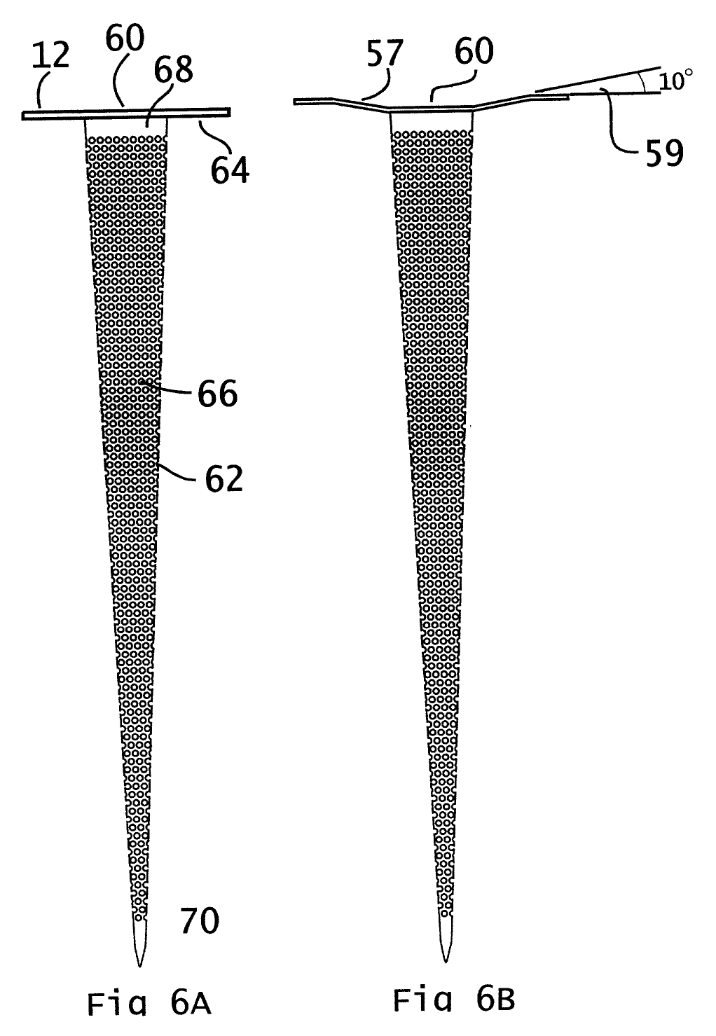

Referring now to FIG. 6 there is shown means for anchoring the body (12) into the soil (14) and means for irrigating the soil at depth beneath the barrier. Members (62) are fixed in a predetermined pattern to the underside of the body (64) so that the body, once placed on soil for cultivation, remains in place. Members (62) comprise elongate conical spikes having a sieve structure (66) of perforations. The spike has a base (68) and an apex (70). The base is fixed to the underside of the body (65) beneath an aperture (60) so that moisture can enter the body of the spike and diffuse into the soil beneath the growth barrier through the sieve structure. The apex is sharp and strong so that it may readily penetrate soil for cultivation without undue forces having to be applied by an individual. The total surface area of the perforations (66), is preferably at least 50% of the ground surface area covered by a single barrier frame. This ensures that water is able to rapidly penetrate the underlying soil at a rate equal to a rate that water would penetrate the soil if the barrier were not in place. For example, a 60 cm by 60 cm barrier, the openings of the irrigation apertures in the surface of the barrier may be less than 180 cm². The total surface area of the conical protrusions preferably exceeds 1800 cm².

The openings of the apertures (60) above each attached spike cover an area given by the formula A=Nπr², where “N” is the number of spikes attached to the underside of the tile beneath irrigation apertures (60), “π” is approximately 3.14159, and “r” is the radius of the opening of each aperture (60). For example, in the embodiment of my invention barrier shown in FIG. 3, there are 30 irrigation apertures. Assuming a 60 cm square barrier with apertures having a radius of 1.25 cm, there is about 150 cm² or about 4% total surface area of the barrier covered by protrusion openings.

The total area of the perforations on the spike is approximated by the formula:

A=Nπ√r\sqrt{r²+h³},

where “N” is the number of irrigation apertures having spikes attached to them, “π” is approximately 3.14159, “r” is the radius of the aperture and “h” is the length of the spike from the base to the apex. In the above example of a 60 cm square with 30 protrusions, a spike length of 20 cm with an opening radius of 1.25 cm results in a total spike surface area of about 2400 cm² or about 66% of the equivalent surface area of the ground the barrier is covering.

To encourage water flow towards the apertures, the frame members may have a slight concave shape (57) that will direct water towards the apertures (60). A slope of about 10% (59) towards the apertures would be appropriate for irrigation purposes.

The spikes act as a reservoir to hold water beneath the surface of the barrier and thereby regulate water infusion into the soil during dry periods. In this embodiment, the barriers may be used for slope stabilization since they allow plants to establish a strong root system. The spikes that are removably attached to the underside of the body may be optionally filled with fertilizer or other chemicals to infuse the soil at root depth in a regulated manner.

The number of conical anchors, the size, number and frequency of perforation, the location, length and diameter of the anchors as well as the apertures in the surface of the tile can all be varied while maintaining the basic principle of my invention.

Preferably, the total area of the bases (68) of the conical anchors fixed to the body does not exceed 5% of the total surface area of the body. Preferably total surface area of the perforations in the conical anchor fixed to the body does not exceed 50% of the total surface area of the body.

In another embodiment of my invention, the conical spikes (62) are removably attached to the body so that an individual can determine a suitable patter for the anchors and removably fix the desired number of anchors to the under surface of the body to achieve a desired anchoring pattern. Grooves on the surface of the body channel water into the apertures above the anchoring spikes. In other embodiment of my invention, the anchors take any shape suitable for easy penetration into soil for cultivation.

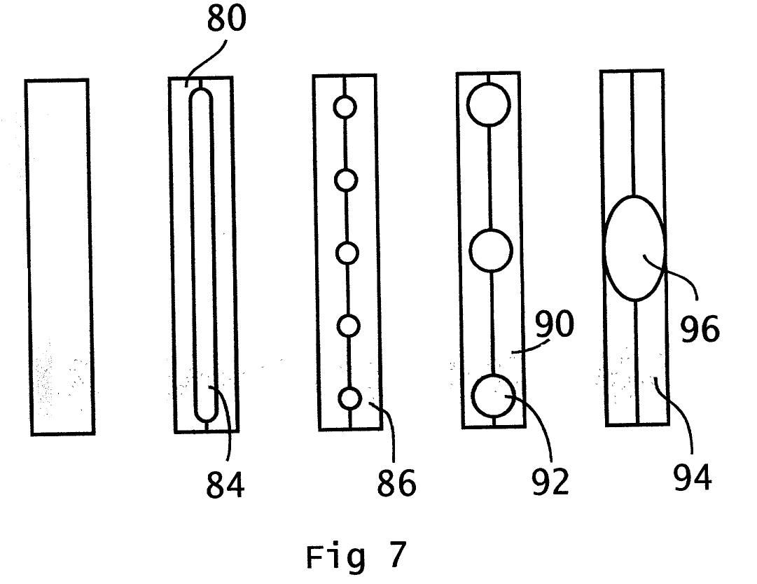

Referring now to FIGS. 4 and 7, there is shown said plant spacing means of an embodiment of my invention. The plant spacing means comprises a rectangular member (80) adapted for being received by a slit (46) in the body (12). These members have a variety of configurations to suit the needs of cultivation. For example, in embodiment (82) the member has no holes and therefore can be placed into a slit to close it to cultivation. The embodiment (80) has one lengthwise slit (84) that effectively narrows the original slit (46) to permit the accurate placement of small seeds and seedlings. Embodiment (86) shows a series of apertures in the member for the accurate linear spacing of seeds or seedlings. Embodiment (90) shows larger apertures (92) adapted for larger plants. Finally, embodiment (94) shows one large aperture (96) for a single large plant. Other patterns are possible and are not to be confined to the examples illustrated herein.

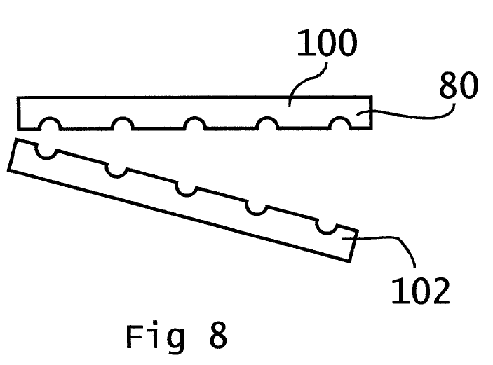

Referring to FIG. 8, each of the members, for example, (80) are split into two halves (100) and (102). This permits easy insertion into the slit (46) and easy removal from a mature plant in halves without damaging the plant growing in it. In another embodiment of my invention, the slit (46) may be closed using a resealable flap having one side fixed to the body.

My invention may be coloured and textured to resemble nature soil. The material of my invention is non-biodegradable and strong enough so that it can be walked upon without damaging the barrier or the plants in it. The material may be any suitable plastic material having suitable thermal gain properties to promote plant growth when exposed directly to solar radiation. Suitable material includes such impermeable materials as ABS plastic, rubber, polycarbonate and glass-reinforced nylon.

As well, my invention may receive a variety of desired plant cultivation patterns. These patters can be easily the body permitting the easy cutting of said pattern into the body by an individual using a sharp tool.

Typically, the growth barrier body of my invention would measure about 60 cm square. However, it could also have a width of 60 cm and any suitable length. To achieve this, the material would be sold in rolls 60 cm wide. The roll of material would be precut to ensure that the joining means were included and pre-wound in lengths suitable for residential land commercial use.

Although this description contains many specificities, these should not be construed as limiting the scope of the invention by merely providing illustrations of some of the embodiment of the invention. Thus the scope of the invention should be determined by the appended claims and their legal equivalents rather than by the examples given.

The embodiments of the invention for which an exclusive property or privilege is claimed are defined as follows:

1. A plant growth barrier comprising;
a. at least one flat rectangular body for removable placement in communication with soil for cultivation said body comprising a frame having a top member, a bottom member a first side member and a second side member where said members are integral to each other and further wherein each member has a width and length so that the surface are of the frame defines the area of prohibited plant growth;
b. a rectangular slit enclosed by the frame members said slit exposing soil for cultivation of desirable plants and further wherein the slits are adapted to receive plant spacing means;
c. means for attaching a plurality of bodies together to define a planting pattern across a predetermined cultivation area;
d. means for irrigating the soil below the growth barrier; and,
e. means for anchoring the body to the soil.

2. The plant growth barrier of claim 1 wherein the body frame further includes at least one additional division member connected to the top and bottom members and parallel to the side members for forming two slits for exposing soil for cultivation and further wherein the divisional member is integral to the body.

3. The plant growth barrier of claim 1 wherein the body frame further includes a plurality of divisional members between the top and bottom members of the frame said division members arranged in equally spaced parallel relationship across the width of the body thereby forming a plurality of equally spaced parallel slits exposing soil for cultivation and further wherein the divisional members are integral to the body.

4. The plant growth barrier of claim 1 wherein means for attaching adjacent bodies together comprise a plurality of flexible “mushroom” shaped projections from the first side member and the top member of the frame of the body and a plurality of flexible “mushroom” shaped slots in the second side member and bottom member of the frame of the body such that when a first and second body are adjacent to each other the projections on one side of the second body and slots of the opposite side of the first body are in adjacent alignment to each other and further so that the bodies are coupled together by pressing the “mushroom” shaped projections of the second body into and under the “mushroom” shaped slots of the first body so that the projections thereby forming an interlocked joint between the two bodies the result being that a plurality of bodies may be tightly interlocked together to define a planting pattern across a predefined cultivation area.

5. The growth barrier as defined in claim 4 wherein the bodies are joined together in a “shiplap” manner so that no light penetrates between the joints between the bodies and no growth is permitted between the joined bodies.

6. The growth barrier of claim 1 wherein the means for attaching the bodies comprises at least one means from a group of means comprising snaps, magnets, pin-in-hole devices and adhesive tape.

7. The growth barrier of claim 1 wherein the means for irrigating the soil below the growth barrier comprises a plurality of apertures in the frame and division members said apertures being circular and adapted to permit sufficient irrigation under the growth barrier without water logging the soil beneath the growth barrier.

8. The growth barrier of claim 7 wherein the apertures are in an equally spaced linear alignment relationship down the centre line of each member.

9. The growth barrier of claim 1 wherein means for anchoring the body to the soil comprises a plurality of anchoring members fixed in a predetermined pattern to the underside of the body so that the body, once placed on soil for cultivation, remains in place.

10. The growth barrier of claim 9 wherein the anchoring members comprise elongate conical spikes wherein each individual spike comprises a sieve structure of perforations said spike having a base and an apex said base fixed to the underside of the body beneath an aperture so that moisture can enter the body of the spike and diffuse into the soil beneath the growth barrier and said apex adapted to readily penetrate soil for cultivation.

11. The growth barrier of claim 10 wherein the total area of the bases of the conical anchors fixed to the body does not exceed 5% of the total surface area of the body.

12. The growth barrier off claim 11 wherein the total surface area of the perforations in the conical anchor fixed to the body does not exceed 50% of the total surface area of the body.

13. The growth barrier of claim 12 wherein the conical spikes are removably attached to the body so that an individual can determine a suitable pattern for the anchors and removably fix the desired number of anchors to the under surface of the body to achieve a desired anchoring pattern.

14. The growth barrier of claim 13 wherein the bodies may contain grooves to channel water from the surface of the body to the openings at the base of each conical anchor.

15. The growth barrier of claim 10 wherein the anchors take any shape suitable for easy penetration into soil for cultivation

16. The growth barrier of claim 1 wherein said plant spacing means comprises a rectangular member adapted for being received by the slit said member having at least one opening adapted for customized plant spacing.

17. The growth barrier of claim 16 wherein the member may have a plurality of openings adapted for customized plant spacing.

18. The growth barrier of claim 17 wherein the member is split down its centre line into two halves for easy insertion into the slit and further wherein the member may be removed from the slit by halves without damaging plants growing therein.

19. The growth barrier of claim 1 wherein the plant spacing member has no openings so that once placed in the slit plant growth is prevented in that slit.

20. The growth barrier of claim 1 wherein the slit may be closed by a resealable flap having one side fixed to the body.

21. The plant growth barrier of claim 1 wherein the body further comprises a raised lip about its circumference in order to retain water on the surface of the body so that it is able to flow through the apertures and into the soil.

22. The plant growth barrier of claim 1 wherein the body is adapted to be textured and coloured to resemble nature soil.

23. The plant growth barrier of claim 1 wherein the body is made from a thermoplastic material having thermal gain properties to promote plant growth when exposed directly to solar radiation.

24. A plant growth barrier comprising;
a. at least one flat rectangular body for placement on soil for cultivation said body prohibiting plant growth there through said body adapted for receiving a desired plant cultivation pattern the body permitting the easy cutting of said pattern into the body by an individual using a sharp tool;
b. means for attaching a plurality of bodies together to define a planting pattern across a predetermined cultivation area;
c. means for irrigating the soil below the growth barrier; and,
d. means for anchoring the body to the soil.

25. The growth barrier of claim 1 and 24 wherein the body is square having a length and width of about 60 centimeters.

26. The growth barrier of claim 25 wherein the body is cut from a strip of suitable material having a width of about 60 centimeters so that an individual may construct a barrier of a desirable predetermined length.

27. The growth barrier of claim 26 wherein said strips are joinable together using joining means.

28. The growth barrier of claim 27 wherein the body may be cut into any desirable shape to fit the contours of the cultivated area.

29. The growth barrier of claim 25 wherein the bodies are manufactured from a resilient, lightweight, strong and non-biodegradable material capable of being walked upon by an individual without deterioration of its properties.

30. The growth barrier of claim 29 wherein the body is manufactured from one of a group of water impermeable materials comprising ABS plastic, rubber, polycarbonate or glass-reinforced nylon.
